(19) United States
(12) Patent Application Publication
(10) Pub. No.: US 2006/0218504 A1
(43) Pub. Date: Sep. 28, 2006

(54) Method and program for managing a plurality of windows

(75) Inventors: Makoto Hiroi, Hamamatsu-Shi (JP); Masahiro Shimizu, Hamamatsu-shi (JP)

Correspondence Address: MORRISON & FOERSTER, LLP, 555 WEST FIFTH STREET, SUITE 3500, LOS ANGELES, CA, 90013-1024, US

(73) Assignee: Yamaha Corporation, Hamamatsu-Shi (JP)

(21) Appl. No.: 11/377,102

(22) Filed: Mar. 15, 2006

(30) Foreign Application Priority Data
Mar. 23, 2005 (JP) 2005-084698

(51) Int. Cl. G06F 3/00

(52) U.S. Cl. 715/781; 715/806; 715/790

(57) ABSTRACT

A plurality of types of windows are simultaneously openable in accordance with an application program, and one or more windows are simultaneously openable for each of the types. One or more types can be designated from among the plurality of types of windows, in accordance with a request of a user. All of windows belonging to the types are extracted from among the windows currently opened on the display, and icons individually representative of all of the extracted windows belonging to the designated types are displayed on the display. When any one of the displayed icons has been selected by the user, the window corresponding to the selected icon is displayed on the display as an active window.

### BACKGROUND OF THE INVENTION

The present invention relates to a method and program for managing a plurality of windows displayed on a display of a computer.

As conventionally known, various application programs running under an operating system (hereinafter referred to as “OS”) of a personal computer (hereinafter referred to as “PC”) can cause windows, corresponding to various application programs, to be displayed on a display of the PC. During some operation with a plurality of application programs activated simultaneously under an OS, a great many of windows of the plurality of application programs are displayed in an overlapping relation to one another with the currently-active window displayed at a frontmost position on the display screen. To extract a necessary or desired window as an active window from among the great many windows displayed on the display in an overlapping relation, it has been conventional for the user to select the desired window of a given application program by performing click operation or the like using a pointing device, such as a mouse, so as to cause the selected window to be displayed at the frontmost position on the display screen. Also known is an approach to display a plurality of buttons, corresponding to various windows currently opened on the display screen, on a so-called task bar on a desktop provided by the OS, so that a desired window of a given application program can be displayed at the frontmost position on the display screen by the user activating, through mouse-click operation or the like, one of the displayed buttons which corresponds to the desired window.

Also known is a technique which, in a case where a plurality of windows of a plurality of application programs are displayed in an overlapping relation to one another, appropriately contracts the size of the windows of the application programs and displays the thus-contracted windows on the display screen in a tile-like arrangement (i.e., tile-display) so as not to overlap with one another. Further, a plurality of windows of a given application programs too can be tile-displayed under control of an OS in a similar manner to the aforementioned.

Further, there have been known application programs, such as “Sol2” (trademark of Yamaha) and “Cubase” (trademark of Steinberg), for implementing various functions (editing, recording, reproduction, etc.) related to music production using a computer; such application programs will hereinafter be referred to as “music production software”. According to such music production software, data as listed below are managed in a hierarchized organization where data related to a window (song screen) for controlling an entire set of music data (i.e., song data) representing a given music piece and contained in a file and for displaying and controlling a plurality of tracks included in the song are set as upper level data and the following data are set as data lower in level than the song data. The lower level data include a plurality of types of data; such as data related to windows for editing data of MIDI tracks (MIDI sequences) of the plurality of tracks; data related to windows (audio editing screens) for editing data of audio waveform tracks (audio waveform data) of the plurality of tracks; data related to a window (MIDI mixer screen) for performing tone volume control etc. on MIDI data reproduced from each of the MIDI tracks; and data related to a window (audio mixer screen) for performing tone volume control etc. on waveform data reproduced from each of the audio waveform tracks. The user can edit any desired data on the plurality of types of windows corresponding to the plurality of types of data.

Namely, with this type of music production software, a plurality of different types of windows are opened simultaneously when an editing operation is to be performed on music data corresponding to a music piece. Further, with the music production software, a plurality of sets of music data corresponding to a plurality of music pieces can be opened simultaneously to perform desired operations on the data. In the case where a plurality of sets of music data corresponding to a plurality of music pieces are opened simultaneously, a desired operation is performed on the individual music data sets with a plurality of types of windows opened for the music data sets.

The arrangements for opening windows of a plurality of types of lower level data for each of one or more upper level data in accordance with a single application program handling hierarchically-organized data are employed in other application programs than the aforementioned music production software, such as an application program that is directed to controlling, via an externally-connected personal computer, mixer engines for performing mixing processing on digital audio signals. With such a type of mixer engine control program, data related to windows for managing and controlling an entire group (zone) of a plurality of mixer engines are set and managed as upper level data, while data related to windows for editing setups of individual mixers (CAD screens) and data related to windows for performing editing etc. on operation parameters of individual components of the mixers are set and managed as low level data.

When some operation is being performed in accordance with a single application program with a plurality of types of windows opened for one or more data, a great many windows tend to be displayed on the display screen in a chaotic manner so that it is often very troublesome for the user to find a necessary window from among the great many windows. Further, when another application program is activated on a computer desktop concurrently with the above-mentioned application program (e.g., music production software), a desired window of desired data of the music production software would be lost in the windows of the other application program, and it tends to be even more troublesome for the user to find the desired window. Similar problem would be encountered in the task bar of the OS; that is, when a great many buttons are being displayed on the task bar, it tends to be very troublesome to find, from among the displayed buttons, a particular button corresponding to a desired window.

### SUMMARY OF THE INVENTION

In view of the foregoing, it is an object of the present invention to provide a method and program which, in an environment where a plurality of types of windows are being opened simultaneously in accordance with a single application program, allow a user to find, with utmost ease, any desired window of the application program from among the plurality of types of windows.

In order to accomplish the above-mentioned object, the present invention provides a method for managing one or more windows currently opened on a display in accordance with a single application program executed by a computer, wherein a plurality of types of windows are simultaneously openable in accordance with the application program and one or more windows are simultaneously openable for each of the types. The method comprises: a first step of designating one or more desired types from among the plurality of types of windows, in accordance with a request of a user; a second step of extracting, from among the windows currently opened on the display, all of windows belonging to the designated types and displaying on the display icons individually representative of all of the extracted windows belonging to the designated types; and a third step of, when any one of the icons displayed on the display has been selected by the user, displaying on the display the window corresponding to the selected icon as an active window.

According to the present invention, once the user designates a desired type from among the plurality of types of windows, processing is performed to extract all of windows belonging to the designated type from among the windows currently opened on the display and to display icons individually representative of all of the extracted windows belonging to the designated type. For the display of the icons, there may be applied, for example, tile display control for arranging, in a tile-like manner, icons representing size-reduced pictographs of the windows. When any one of the icons displayed on the display has been selected by the user, the window corresponding to the selected icon is displayed on the display as an active window. In this way, the present invention achieves the superior benefit that the user is allowed to find, with an increased ease, a desired one of the plurality of windows currently opened on the display in accordance with the single application program.

The present invention may be constructed and implemented not only as the method invention as discussed above but also as an apparatus invention. Also, the present invention may be arranged and implemented as a software program for execution by a processor such as a computer or DSP, as well as a storage medium storing such a software program. Further, the processor used in the present invention may comprise a dedicated processor with dedicated logic built in hardware, not to mention a computer or other general-purpose type processor capable of running a desired software program.

The following will describe embodiments of the present invention, but it should be appreciated that the present invention is not limited to the described embodiments and various modifications of the invention are possible without departing from the basic principles. The scope of the present invention is therefore to be determined solely by the appended claims.

### BRIEF DESCRIPTION OF THE DRAWINGS

For better understanding of the objects and other features of the present invention, its preferred embodiments will be described hereinbelow in greater detail with reference to the accompanying drawings, in which:

FIG. 1A is a diagram showing an example of a personal computer for executing music production software in accordance with an embodiment of the present invention;

FIG. 1B is a diagram schematically showing an example display on a display device of the personal computer during music production through execution of the music production software;

FIG. 1C is a diagram showing an example manner in which windows are tile-displayed in accordance with the embodiment of the invention;

FIG. 2 is a diagram showing a hierarchical organization of song data handled by the music production software;

FIG. 3A is a diagram showing an example of a “song window” that is a main screen of the music production software;

FIG. 3B is a diagram showing an example of a window for customizing a navigation bar in the embodiment;

FIG. 4A is a flow chart showing an example operational sequence of a tile display process that is performed in the embodiment in response to an instruction by a user;

FIG. 4B is a flow chart showing an example operational sequence of a window selection process performed in the embodiment;

FIG. 5 is a diagram showing another example of the navigation screen; and

FIG. 6 a diagram showing still another example of the navigation screen.

### DETAILED DESCRIPTION OF THE INVENTION

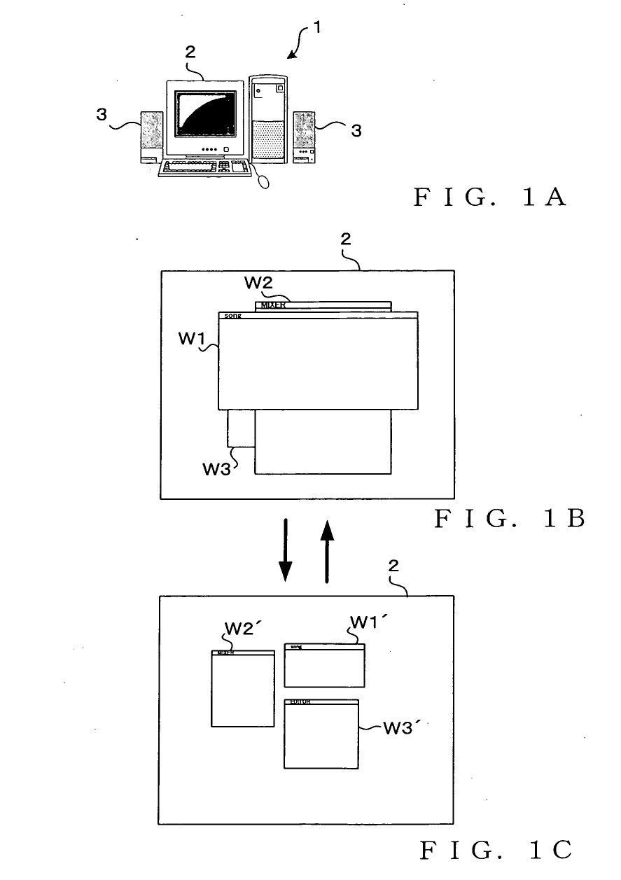

FIGS. 1A-1C schematically show an embodiment of the present invention, of which FIG. 1A shows an example of a general-purpose personal computer (PC) for executing music processing software in the embodiment of the invention. As shown, the PC 1 comprises a computer body, and a display device 2, mouse, keyboard and speaker 3 connected to the computer body. Application program (music production software) for performing computer-based music production is executed under the OS of the PC 1. The music production software has various functions necessary for the computer-based music (song) production, such as a sequencer function, functions for performing editing, mixing etc, on audio waveform data and MIDI sequences (i.e., trains of MIDI data with time information added thereto). On a sequencer of the music processing software, the user can produce music (song data) by recording audio waveform signals on a given track to thereby create an audio waveform track and recording sequentially-input data of the MIDI format (i.e., MIDI data) on another track along with time information indicative of respective input times to thereby create a MIDI track containing a MIDI sequence. On the display device 2, there are displayed different types of mutually-independent windows in accordance with various functions performed by the music production software, such as editing of the MIDI sequence or audio waveform data, mixing adjustment and adjustment of parameters of effecters to be inserted. The user can perform editing operations on various data on various windows. Most of the editing operations, such as entry, change, copying, deletion, etc. of various data, can be carried out via a GUI-based display screen using a pointing device, such as a mouse. Waveform data generated by reproducing produced song data can be monitored via the speaker 3.

FIG. 1B schematically shows an example display on the display device 2 of the PC 1 during music production through execution of the music production software. Namely, on the display device 2, there are opened a plurality of types of windows W1, W2, W3, . . . , such as a song window for controlling entire editing of music data (song data) and editing windows for various types of data, and these opened windows W1, W2, W3, . . . are displayed in an overlapping relation to one another. In multi-window environments, as well known, a currently-active window (window W1 in the illustrated example of FIG. 1B) is displayed at the frontmost position on the display screen so as to receive operating inputs, while the other windows are positioned behind the currently-active window. With the music production software employed in the instant embodiment, a plurality of song data can be opened, and a plurality of types of windows are opened for each of the plurality of song data.

As schematically shown in FIG. 1B and as will be later detailed, windows of a user-designated type (e.g., windows W1-W3) can be extracted from a plurality of windows opened on the display device 2 in accordance with the music production software, and icons W1′-W3′ representative of the extracted windows are tile-displayed on the display device 2. FIG. 1C shows an example manner in which the icons W1′-W3′ representative of the extracted windows are tile-displayed. It will become apparent from the description hereinbelow that, by the icons of the windows of the user-designated type pertaining to the user-designated data being displayed in accordance with the present invention, the user is allowed to find, with an increased ease, any desired window from among the plurality of windows.

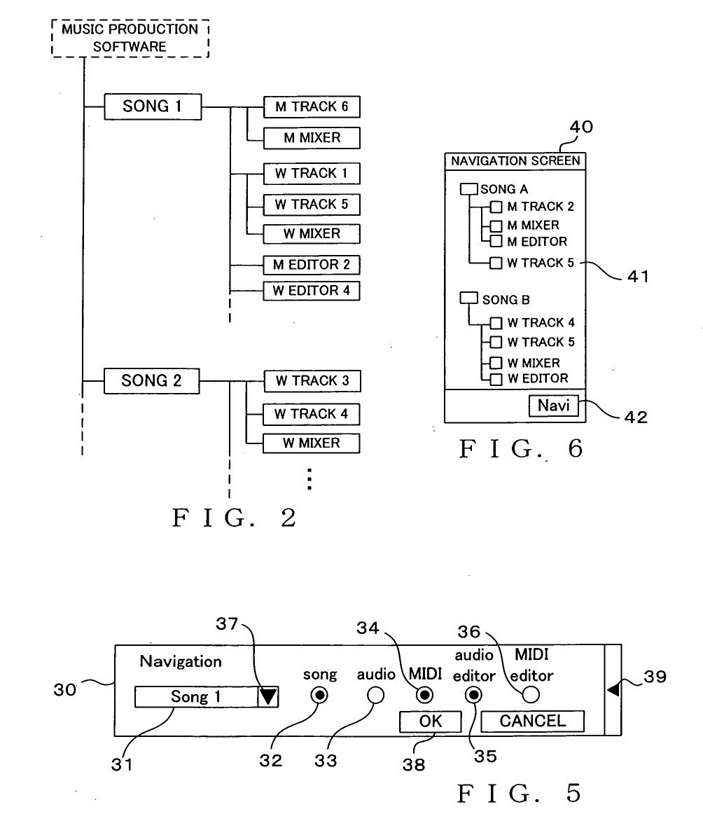

FIG. 2 is a diagram showing a hierarchical organization of a plurality of windows opened at a given time point during editing of song data based on the music production software. Song data of a plurality of music pieces (song 1, song 2, . . . ) can be stored in a file of the music production software. According to the music production software, a song window of particular song data to be edited is first opened, and then windows of various data of the song data are opened, as lower-level windows, from the song window. The lower-level windows openable from the song windows (song 1, song 2, . . . ) include: MIDI track windows (M track 1, M track 2, . . . ) for editing data of MIDI tracks (MIDI sequences); MIDI mixer windows (M mixers) for performing tone volume control on MIDI data reproduced from the MIDI tracks; waveform track windows (W track 1, W track 2, . . . ) for editing data of audio waveform tracks (waveform data); a waveform mixer window (W mixer) for performing tone volume control on waveform data reproduced from the audio waveform tracks; waveform effect editor windows (W editors) for performing parameter setting etc. for plug-in effects to be inserted in channels of the waveform mixer; MIDI tone generator editor windows (M editors) for performing parameter setting etc. for tone generators (external tone generators and plug-in software tone generators) to which the MIDI data reproduced from the MIDI tracks are to be transmitted; and so on. Each of the song data includes data of a plurality of MIDI tracks, data of a MIDI mixer, data of a plurality of audio waveform tracks, data of a waveform mixer, data of a plurality of plug-in effects, and data of a plurality of tone generators. Each of the data in each of the song data can be edited on the corresponding lower-level window. It should be note here that FIG. 2 shows only a tree of windows being opened at a given time point but does not show all of data constituting the individual songs. For example, if any one of the song data has one or more other audio waveform tracks whose windows have not yet been opened at a given time point, the other audio waveform tracks can be opened at other time points. Further, from any one of these lower-level windows, further-lower-level windows (not shown), one level lower than the lower-level window, can be opened for editing of data included in the data in question, such as track names and various setting data. According to the music production software, editing of any desired one of the data constituting the song data can be performed by newly opening a window corresponding to the data type.

Now, a description will be given about operations for creating a music piece (song data) in accordance with the music production software.

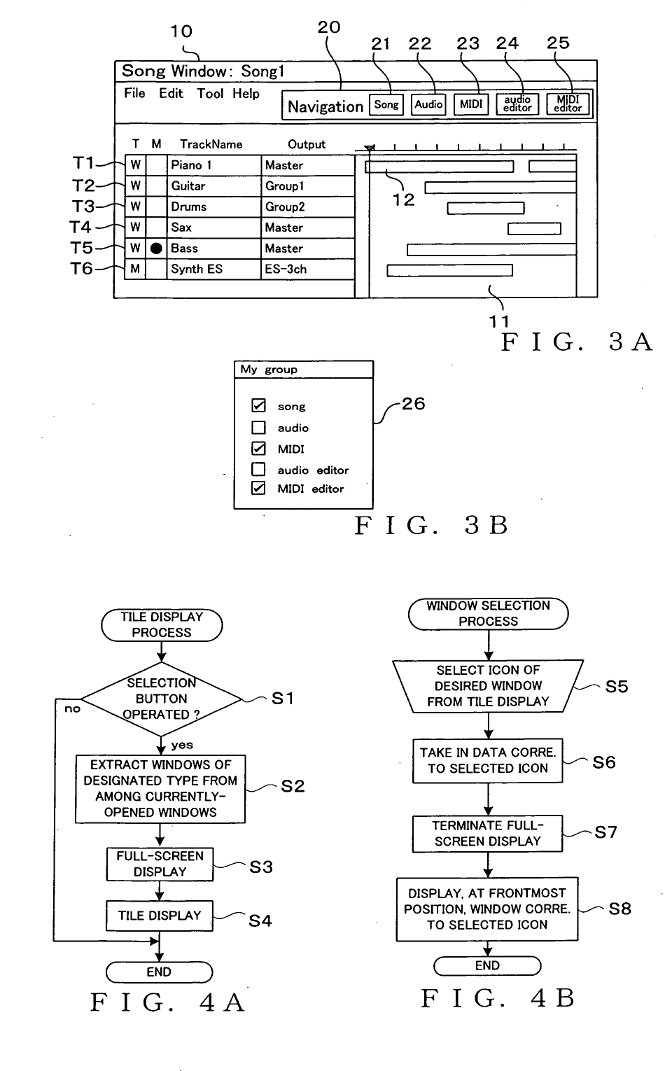

FIG. 3A shows an example of a “Song Window” 10 that is a main screen for controlling the whole of one song data. In the figure, the name of the music piece (i.e., song name) being currently created (in the illustrated example, a string of letters “Song 1”) is displayed to the right of a string of letters indicative of the name of the window (“Song Window”) indicated in an upper-end portion of the song window 10. Such a song window 10 is prepared for each individual song data, so that, when a plurality of song data are being opened in accordance with the music production software, a plurality of such song windows corresponding to these song data are opened. On the song window 10, there is displayed a list of all tracks (i.e., audio waveform tracks and MIDI tracks) constituting the song data. On the song window 10, the user can perform music editing, such as creation/deletion of any one of the audio waveform tracks and MIDI tracks or a partial data block (region) thereof. In the illustrated example of FIG. 3A, tracks T1-T6 are set as tracks constituting the song data.

Each of the tracks T1-T6 is assigned a unique track name; in the illustrated example, track names “Piano”, “Guitar”, etc. are displayed on the window. Track identifier display area “T” is provided at the left end of each of the tracks T1-T6. The track identifier is in the form of a letter “W” or “M” which indicates whether the data recorded on the track is audio waveform data or a MIDI sequence (i.e., a train of MIDI data with time information). Namely, the identifier “M” represents a track of a MIDI sequence or MIDI track (track T6 in the illustrated example), while the identifier “W” represents a track of an audio waveform data or audio waveform track (tracks T1-T5 in the illustrated example). Further, an ON/OFF setting display area “M”, indicative of the ON/OFF state of each of the tracks T1-T6, is provided to the right of the track identifier display area “T”. In the illustrated example, a small black circle “●” indicates that the track is in a mute-ON state. Further, in an “Output” field, output destinations of the data recorded on the individual tracks are indicated. Further, in the figure, “Master” indicates that the data should be output to a stereo bus for mixing ultimate stereo outputs in the waveform mixer (i.e., “master output”), and “Group 1” and “Group 2” each indicates that the data should be output to a single group bus for performing group-specific mixing as preprocessing in the waveform mixer. Furthermore, in the figure, “ES-3ch” indicated as an output destination of the MIDI track T6 means that MIDI data reproduced from the track T6 should be sent to a plug-in software tone generator “ES”.

On a time line area 11 of the song window 10, there are displayed band-shaped indications 12 (in FIG. 3A, reference numeral 12 is attached to only one of the band-shaped indications for simplicity of illustration), each of which indicates a data block (audio waveform data or MIDI sequence) corresponding to contents of a performance (hereinafter “performance contents”) recorded on one of the tracks T1-T6. The horizontal axis of the time line 11 represents time. Each of the data blocks is displayed in a horizontal band at a position corresponding to one of the tracks T1-T6 it belongs to. Namely, the vertical position, on the window, of each of the data blocks corresponds to that of one of the tracks T1-T6 it belongs to, and the horizontal vertical position, on the window, of each of the data blocks represents a time position of the data block in the music piece in question.

The user can designate the data block on each of the tracks through predetermined operation, such as mouse-click operation, to thereby open the window for editing data (audio waveform data or MIDI sequence) of performance contents corresponding to the designated data block.

On the window for editing performance contents of audio waveform data (W track), the user can edit, for example, a frequency characteristic, variation over time of a tone volume, time-axial position, etc. of the audio waveform data of the data block. Further, on the window for editing performance contents of a MIDI sequence (M track), the user can add any desired new event to events (MIDI data with time information) included in the MIDI sequence of the data block, delete any of the existing events, and change the MIDI data and time information of any of the existing events. Among examples of such a window are a so-called “musical score window” and “piano roll window”.

Further, the user can open a plurality of types of windows in accordance with an operation to be performed, such as: a window (M mixer) for performing tone volume control etc. on MIDI data reproduced from a MIDI track; a window (W mixer) for performing tone volume control, panning setting and effect-send-level setting on waveform data reproduced from the individual waveform tracks; a window (W editor) for performing parameter setting etc. for a plug-in effect to impart an effect to audio waveform data; and a window (M editor) for performing parameter setting for a tone generator that is an output destination of MIDI data reproduced from a MIDI track. The user can perform a data editing operation corresponding to the function of each of the opened windows, via the GUI-based display screen.

In an upper portion of the song window 10, there is provided a “menu bar” 12 where classes obtained by classifying fundamental commands according to the function are displayed in a row as iconized buttons. In the illustrated example of FIG. 3A, “File”, “Edit”, “Tool” and “Help” are the function-specific classes displayed on the menu bar 12 of the music production software. As the user clicks on any one of the iconized buttons on the screen, a group of commands classified into the function corresponding to the clicked-on button are displayed on a drop-down menu, and the user can designate, from the drop-down menu, one of the commands which corresponds to an operation to be performed. For example, by first clicking on the “File” button, the user can give a command for creation of new song data, storage of song data, opening of song data, or the like.

Further, in FIG. 3A, reference numeral 20 represents a “Navigation” bar for displaying a button (icon) indicative of a navigation function employed in the embodiment of the present invention. This navigation function is intended to extract one or more windows of a user-designated type from among a plurality of windows currently opened on the display screen and then tile-display the thus-extracted windows. Namely, various components of the song data handled by the music production software, explained above in relation to FIG. 2, are grouped into particular categories in accordance with the type of the window, and one or more windows corresponding to the data grouped into the user-designated type are extracted in response to a user instruction.

A plurality of buttons 21-25 displayed in the navigation bar 20 are selection buttons for selecting any desired one of window types corresponding to the class names representative of various types of the data; that is, the buttons 21-25 indicate a list of the window types. The user can select a desired type of windows to be extracted, by selectively activating a desired one of the selection buttons 21-25. The “Song” button 21 corresponds to a class into which all types of windows, currently opened in relation to the song data, are grouped. In other words, the “Song” button 21 corresponds to the “song” class and is operable to select all types of windows currently opened in relation to the song data. The “Audio” button 22 corresponds to a class into which waveform track windows (W tracks) and waveform mixer window (W mixer), currently opened in relation to the song data, are grouped. The “MIDI” button 23 corresponds to a class into which MIDI track windows (M tracks) and MIDI mixer window (M mixer), currently opened in relation to the song data, are grouped. Further, the “audio editor” button 24 corresponds to a class into which waveform effect editor windows (W editors), currently opened in relation to the song data, are grouped. Furthermore, the “MIDI editor” button 25 represents a class into which MIDI tone generator editor windows (M editors), currently opened in relation to the song data, are grouped. Note that the classification of the window types are not limited to the above-mentioned five classes.

The user may change as desired the settings of the window type selection buttons displayed on the navigation bar 20, so as to customize the navigation bar 20. FIG. 3B shows an example of a window for customizing the navigation bar 20 as desired by the user. On the window 26 for customizing the navigation bar 20, the user can set the types of buttons to be displayed on the navigation bar 20, by checking checkboxes corresponding to desired window types. The thus-made settings can be stored in memory along with an appropriate name (“My group” in the illustrated example). More specifically, in the illustrated example of FIG. 3B, three window types, “song”, “MIDI” and “MIDI editor”, are registered under the name “My group”.

FIG. 4A is a flow chart showing an example operational sequence of a tile display process that is performed in response to an instruction by the user. During the music production based on execution of the music production software, a plurality of types of windows W1, W2, W3, . . . , such as song windows, waveform track windows (W tracks) and MIDI track windows (M tracks), are opened on the display device 2 of the PC in relation to one or more song data. The user can operate a desired one of the plurality of types of windows by operating one of the selection buttons, displayed on the navigation bar 20, which corresponds to the desired type (step S1 of FIG. 4A). At next step S2, one or more windows of the type designated by the user's operation of the selection button are extracted from among all of the windows currently opened on the display 2. When, for example, the “Audio” button 22 has been operated in the state shown in FIG. 2, three windows, i.e. “W track 1”, “W track 5” and “W mixer”, are extracted. Further, when the “MIDI editor” button 25 has been operated in the state shown in FIG. 2, only one window, “M editor”, is extracted. At step S3, the music production software performs control to remove all indications on the display screen and shift the display to a full-screen display mode to prepare for subsequent tile display. Then, at step S4, the windows extracted at step S2 above are each converted into a smaller-size icon, and then these icons indicative of the windows of the user-designated type are tile-displayed on the display device 2. With such tile display control, the icons of the individual windows are displayed on the display screen in such a manner that they do not overlap one another on the display screen (see FIG. 1C). Note that the icon of each of the windows is provided by reducing the size of a pictograph of the window, and thus, the user can clearly identify the windows from the pictographs represented by the corresponding icons. In the aforementioned manner, the user can extract one or more windows of a particular type, belonging to given song data, from among a plurality of currently-opened windows and glance through the respective contents of the extracted windows on the basis of tile-displayed icons of the extracted windows, with the result that the user can find, with an increased ease, any desired window from among the plurality of currently-opened windows.

FIG. 4B is a flow chart showing an example operational sequence of a process for selecting a desired window from among the tile-displayed windows. The tile-displayed windows are in the form of iconized buttons, and the user can designate the icon of any desired window, through mouse-click operation or the like, to select the desired window (step S5). At step S6, data corresponding to the selected window are taken in. Then, at step S7, the music production software performs control to terminate the full-screen display, so as to shift the display back to the previous operating screen of the music production and display the selected window at the frontmost position as a currently-active window.

Although FIGS. 4A and 4B illustratively show the processes where the full-screen display control and tile display control is performed by the music production software, the present invention is not so limited. For example, the full-screen display control and tile display control may be performed by the OS.

Further, whereas FIG. 3A illustratively shows the navigation bar 20 as displayed on the main screen (i.e., song window), the navigation bar 20 may be displayed independently of the main screen. Furthermore, the navigation bar 20 independent of the main screen may always be displayed at the frontmost position in a similar manner to a modified navigation screen 30 to be described below.

Furthermore, the display indicating the navigation function (i.e., navigation bar 20) has been described, in relation to FIG. 3A, as displayed the form of a tool bar on the main screen (i.e., song window). FIG. 5 shows another example of the display indicating the navigation function (i.e., navigation screen).

On the navigation screen 30 of FIG. 5, there are provided a song data selection field 31 and checkboxes 32-36 for selecting a particular type of one or more window to be extracted. In the song data selection field 31, a list of song data stored in a file of the music production software is displayed, for example, as a pull-down menu. The user can select any desired song data from the list, as an object of the navigation function. The checkboxes 32-36 for selecting a desired window type correspond to particular groups (in the illustrated example of FIG. 5, “song”, “audio”, “MIDI”, “audio editor” and “MIDI editor”) corresponding to various window types, and the user can check any one of the checkbox 32-36, corresponding to a desired type of windows to be extracted, to select the desired window type as an object of the navigation function, Note that two or more window types may be selected at the same time. On the navigation screen 30 of FIG. 5, the user can select desired song data and then, for the selected song data, select a desired type of windows to be extracted for subsequent tile display. Execution of the tile display control according to the settings made on the navigation screen 30 may be instructed by operation of an “OK” button 38.

Display control may be performed such that the navigation screen 30 is always displayed at the frontmost position of the operating screen of the music production software, in order to prevent the navigation screen 30 from being hidden behind other windows when a plurality of windows are opened simultaneously. Further, the navigation screen 30 may have an expandable/contractible size. For example, the size of the navigation screen 30 may be contracted into a smaller size by the user performing leftward mouse-drag operation on a tab portion 39 provided to the right of the navigation screen 30; thus, when the navigation screen 30 is unnecessary, it can be contracted so as not to disturb another operation.

FIG. 6 shows still another example of the display indicating the navigation function (i.e., navigation screen). On the navigation screen 40 of FIG. 6, there is provided a song data/window type selection field 41 where a plurality of windows opened at a given time point during song data editing of the music production software are displayed in a hierarchical (or tree-shaped) structure. The song data/window type selection field 41 includes a checkbox for each item (i.e., for each of the hierarchized data) displayed. The user can select a data/window type to be subjected to tile display, by checking the checkbox corresponding to the desired data/window type. Execution of the tile display control according to the settings made on the navigation screen 40 may be instructed by operation of a “Navi” button 42 that is a navigation function instruction button provided in a lower end portion of the navigation screen 40.

According to the embodiment having been described above, one or more windows of a designated type, belonging to song data designated by the user, are extracted from among a plurality of currently-opened windows and tile-displayed. Thus, the user can find, with an increased ease, any desired window from among the plurality of currently-opened windows.

Whereas the embodiment has been described in relation to the case where the basic principles of the present invention are applied to music production software, the present invention is not so limited. For example, the present invention is applicable to any other programs than the music production software, such as a control program for the above-mentioned mixer, as long as each of the programs allows a plurality of windows to be opened for a plurality of data to permit an operation on the data. Namely, this type of mixer engine control program may be constructed to allow the user to select desired zone data from among a plurality of zone data and designate a particular type of one or more windows to be extracted (such as a CAD screen or component editing screen type) so that the designated windows of the user-designated data can be tile-displayed.

The display style of the navigation function, way of selecting desired data and window type, etc. may be other than the above-described, as long as they allow the user to designate one desired data from among a plurality of data currently opened in accordance with an application program, designate a particular window type from among a plurality of window types and extract windows of the designated window type so that icons of the extracted windows can be tile-displayed.

Furthermore, although the embodiment has been described in relation to the case where the display is shifted to the full-screen display mode so as to tile-display the extracted windows, the present invention is not so limited. For example, arrangements may be made such that a predetermined icon display area (dock) is prepared in response to an instruction by the user and icons of windows of a user-designated type are displayed in the display dock for user-designated data, to allow the user to find a desired window on the basis of the icons in the dock. Namely, the present invention only has to be constructed so that icons corresponding to windows of a user-designated type are displayed on the display screen, in such a layout as to provide good visibility, so that the user can find any desired window with an increased ease.

What is claimed is:

1. A method for managing one or more windows currently opened on a display in accordance with a single application program executed by a computer, wherein a plurality of types of windows are simultaneously openable in accordance with the application program and one or more windows are simultaneously openable for each of the types, said method comprising:
a first step of designating one or more desired types from among the plurality of types of windows, in accordance with a request of a user;
a second step of extracting, from among the windows currently opened on the display, all of windows belonging to the types designated via said first step and displaying, on the display, icons individually representative of all of the extracted windows belonging to the designated types; and
a third step of, when any one of the icons displayed on the display has been selected by the user, displaying on the display the window corresponding to the selected icon as an active window.

2. A method as claimed in claim 1 wherein said second step performs control to display the icons, individually representative of all of the extracted windows belonging to the designated types, on the display in such a manner that the icons are arranged on the display in a non-overlapping relation to each other.

3. A method as claimed in claim 1 wherein the windows openable in accordance with the application program are hierarchized, and
said first step includes a step of designating an upper hierarchical level, and a steep of designating a user-desired type of window from among lower hierarchical levels belonging to the designated upper hierarchical level.

4. A method as claimed in claim 1 wherein said first step includes a step of providing a visual indication listing various types of window, to cause the user to designate any desired one of the types on the basis of the visual indication.

5. A method as claimed in claim 4 wherein said visual indication includes icons corresponding to the various types, and a desired type of window is designated by the user selecting one of the icons which corresponds to the desired type.

6. A method as claimed in claim 4 which further comprises a step of changing, in accordance with selecting operation by the user, the types to be listed by said visual indication.

7. A method as claimed in claim 4 wherein said visual indication is always displayed at a frontmost position of a screen of the display.

8. A method as claimed in claim 4 wherein said visual indication is a tool-bar-like indication where icons corresponding to the various types are arranged.

9. A method as claimed in claim 4 wherein said visual indication is an independent window-like indication for causing the user to select a desired one of the types.

10. A method as claimed in claim 4 wherein the windows openable in accordance with the application program are hierarchized, and
said visual indication indicates a tree of indications corresponding to the various types, in accordance with a hierarchical structure of the windows.

11. A method as claimed in claim 1 wherein said application program is a program for carrying out music production using a computer.

12. A window management program for execution by a computer, said window management program being a program for managing one or more windows currently opened on a display in accordance with a single application program executed by a computer, wherein a plurality of types of windows are simultaneously openable in accordance with the application program and one or more windows are simultaneously openable for each of the types, said window management program comprising:
a first step of designating one or more desired types from among the plurality of types of windows, in accordance with a request of a user;
a second step of extracting, from among the windows currently opened on the display, all of windows belonging to the types designated via said first step and displaying, on the display, icons individually representative of all of the extracted windows belonging to the designated types; and
a third step of, when any one of the icons displayed on the display has been selected by the user, displaying, on the display, the window corresponding to the selected icon as an active window.

13. A window management program as claimed in claim 12 which is contained in said application program.

14. A window management program as claimed in claim 12 wherein said application program is a program for carrying out music production using a computer.

15. An apparatus for managing one or more windows currently opened on a display in accordance with a single application program executed by a computer, wherein a plurality of types of windows are simultaneously openable in accordance with the application program and one or more windows are simultaneously openable for each of the types, said apparatus comprising:
a first section that designates one or more desired types from among the plurality of types of windows, in accordance with a request of a user;
a second section that extracts, from among the windows currently opened on the display, all of windows belonging to the types designated via said first section and displays, on the display, icons individually representative of all of the extracted windows belonging to the designated types; and
a third section that, when any one of the icons displayed on the display has been selected by the user, displays, on the display, the window corresponding to the selected icon as an active window.
